(19) United States
(12) Patent Application Publication
(10) Pub. No.: US 2024/0298054 A1
(43) Pub. Date: Sep. 5, 2024

(54) CLOUD RENDERING METHOD AND DEVICE

(71) Applicant: Alipay (Hangzhou) Information Technology Co., Ltd., Hangzhou (CN)

(72) Inventors: Bo XIAO, Hangzhou (CN); Linsheng Li, Hangzhou (CN)

(21) Appl. No.: 18/427,244

(22) Filed: Jan. 30, 2024

(30) Foreign Application Priority Data
Mar. 3, 2023 (CN) 202310221018.3

(51) Int. Cl. H04N 21/258

(52) U.S. Cl. CPC H04N 21/25825

(57) ABSTRACT

The present specification provides a cloud rendering method, applied to a cloud phone server corresponding to a terminal device. The cloud phone server is configured to provide a rendering service for the terminal device. The method includes: receiving interaction data sent by the terminal device, and generating a rendering instruction based on the interaction data; and sending the rendering instruction to a computing serving end connected to the cloud phone server, so that the computing serving end parses the rendering instruction, performs image rendering based on a parsing result to generate a video stream, and returns the video stream to the terminal device, to cause the terminal device to perform display based on the video stream, where a rendering capability of the cloud phone server is lower than a rendering capability of the computing serving end.

### CROSS-REFERENCE TO RELATED APPLICATIONS

The present application is based upon and claims priority to Chinese Patent Application No. 202310221018.3, filed on Mar. 3, 2023, the entire content of which is incorporated herein by reference.

### TECHNICAL FIELD

Embodiments of the present specification relate to the field of cloud computing technologies, and in particular, to a cloud rendering method and device.

### BACKGROUND

A metaverse is a virtual world that is constructed by human beings by using digital technologies, mirrors or transcends the real world, and can interact with the real world. The metaverse relies heavily on an image rendering capability, and therefore, has a very high requirement on an image rendering capability of a terminal device that runs various types of metaverse games or applications. Generally, only a terminal device that has strong hardware performance can satisfy the image rendering capability needed by various types of metaverse games or applications. Consequently, costs are high, and an actual use need of users cannot be satisfied.

### SUMMARY

According to a first aspect, the present specification provides a cloud rendering method, applied to a cloud phone server corresponding to a terminal device. The cloud phone server is configured to provide a rendering service for the terminal device, and the method includes: receiving interaction data sent by the terminal device, and generating a rendering instruction based on the interaction data; and sending the rendering instruction to a computing serving end connected to the cloud phone server, so that the computing serving end parses the rendering instruction, performs image rendering based on a parsing result to generate a video stream, and returns the video stream to the terminal device, to cause the terminal device to perform display based on the video stream, where a rendering capability of the cloud phone server is lower than a rendering capability of the computing serving end.

According to a second aspect, the present specification provides a cloud rendering method, applied to a computing serving end connected to a cloud phone server. The cloud phone server is configured to provide a rendering service for a terminal device, and the method includes: receiving a rendering instruction sent by the cloud phone server, where the rendering instruction is generated by the cloud phone server based on received interaction data sent by the terminal device; parsing the rendering instruction, and performing image rendering based on a parsing result to generate a video stream; and sending the video stream to the terminal device, so that the terminal device performs display based on the video stream, where a rendering capability of the cloud phone server is lower than a rendering capability of the computing serving end.

According to a third aspect, the present specification provides a cloud phone server. The cloud phone server corresponds to a terminal device and is configured to provide a rendering service for the terminal device. The cloud phone server includes: a processor; and a memory storing instructions executable by the processor, wherein the processor is configured to: receive interaction data sent by the terminal device, and generate a rendering instruction based on the interaction data; and send the rendering instruction to a computing serving end connected to the cloud phone server, so that the computing serving end parses the rendering instruction, performs image rendering based on a parsing result to generate a video stream, and returns the video stream to the terminal device, to cause the terminal device to perform display based on the video stream, where a rendering capability of the cloud phone server is lower than a rendering capability of the computing serving end.

According to a fourth aspect, the present specification provides a computing serving end connected to a cloud phone server. The cloud phone server is configured to provide a rendering service for a terminal device. The computing serving end includes: a processor; and a memory storing instructions executable by the processor, wherein the processor is configured to: receive a rendering instruction sent by the cloud phone server, where the rendering instruction is an instruction generated by the cloud phone server based on received interaction data sent by the terminal device; parse the rendering instruction, and perform image rendering based on a parsing result to generate a video stream; and send the video stream to the terminal device, so that the terminal device performs display based on the video stream, where a rendering capability of the cloud phone server is lower than a rendering capability of the computing serving end.

According to a fifth aspect, the present specification provides a non-transitory computer-readable storage medium. The computer-readable storage medium stores a computer program that, when executed by a processor, causes the processor to perform the cloud rendering method according to the first aspect.

According to a sixth aspect, the present specification provides a non-transitory computer-readable storage medium. The computer-readable storage medium stores a computer program that, when executed by a processor, causes the processor to perform the cloud rendering method according to the second aspect.

### BRIEF DESCRIPTION OF DRAWINGS

FIG. 1 is a schematic diagram illustrating a cloud rendering system, according to some example embodiments.

FIG. 2 is a schematic flowchart illustrating a cloud rendering method, according to some example embodiments.

FIG. 3 is a schematic flowchart illustrating a cloud rendering method, according to some example embodiments.

FIG. 4 is a schematic diagram illustrating a cloud rendering apparatus, according to some example embodiments.

FIG. 5 is a schematic diagram illustrating a cloud rendering apparatus, according to some example embodiments.

FIG. 6 is a schematic diagram illustrating a computing device, according to some example embodiments.

### DETAILED DESCRIPTION OF EMBODIMENTS

Example embodiments are described in detail here, and presented in the accompanying drawings. When the following description relates to the accompanying drawings, unless specified otherwise, same numbers in different accompanying drawings represent same or similar elements. Implementations described in the following example embodiments do not represent all implementations consistent with one or more embodiments of the present specification. On the contrary, the implementations are only examples of apparatuses and methods that are described in the appended claims in detail and consistent with some aspects of one or more embodiments of the present specification.

It is worthwhile to note that, steps of corresponding methods in other embodiments are not necessarily performed in the order shown and described in the present specification. Methods in some other embodiments can include more or fewer steps than those described in the present specification. In addition, a single step described in the present specification may be divided into a plurality of steps for description in other embodiments, and a plurality of steps described in the present specification may also be combined into a single step for description in other embodiments.

In addition, user information (including but not limited to user equipment information, user personal information, etc.) and data (including but not limited to data used for analysis, stored data, and displayed data) involved in this application are information and data that are authorized by a user or that are fully authorized by each party, and related data needs to be collected, used, and processed in compliance with relevant national and regional laws, regulations, and standards, and be provided with a corresponding operation portal for the user to authorize or reject.

As described above, the metaverse relies heavily on an image rendering capability, and therefore, has a very high requirement on an image rendering capability of a terminal device that runs various types of metaverse games or applications. In some implementations, a cloud phone can be used to provide a cloud rendering service for a terminal device, so that a terminal device with a common hardware condition can also, e.g., display a smooth and clear picture.

A cloud phone is a mobile phone operating system that runs on a cloud server. The cloud phone is an important cloud infrastructure on a future metaverse mobile terminal application. The cloud phone can satisfy a plurality of application scenarios (for example, VR/AR games), to achieve cloud-based computing power, terminal offloading, and lightweight terminals, thereby improving immersion and interaction of a user. The cloud phone is mainly based on an ARM ecosystem. In the ARM ecosystem, most cloud phone servers are central processing unit (CPU) servers. However, the CPU may be unable to perform reliable rendering.

In some embodiments of the present specification, to implement efficient and reliable cloud rendering, an additionally disposed graphics processing unit (GPU) server dedicated to the cloud phone can be used, for example, a container cloud phone implemented based on a container technology and a cloud phone implemented based on a virtualization technology such as a KVM. Although both the CPU and the GPU can perform image rendering, the GPU runs in a relatively different way. GPU rendering acceleration can be used, and large-scale parallel architectures that include thousands of smaller and more efficient cores are used to process a rendering task simultaneously. Therefore, in the case of the same rendering workload, the GPU performs image rendering faster and more efficiently. Consequently, implementation costs of the cloud phone are greatly increased, and large-scale deployment and application of the cloud phone are hindered. In addition, because GPU servers used in these cloud phone solutions are usually dedicated to the cloud phone and cannot be used for another purpose, GPU utilization is very low, resulting in the waste of computing resources.

In some embodiments of the present specification, to further implement efficient and reliable cloud rendering, a rendering instruction to be executed on a cloud phone server is forwarded to a computing serving end with a strong rendering capability, so that the computing serving end performs image rendering, thereby further reducing implementation costs of a cloud phone while ensuring cloud rendering efficiency.

During implementation, the cloud phone server can receive interaction data uploaded by a terminal device corresponding to the cloud phone server, and generate a series of rendering instructions based on the interaction data. Then the cloud phone server can forward the rendering instruction to a computing serving end connected to the cloud phone server, so that the computing serving end performs image rendering based on the rendering instruction to generate a video stream to be displayed, and returns the video stream to the terminal device, to cause the terminal device to perform display based on the received video stream.

In the above technical solutions of the present specification, considering that existing cloud phone servers are basically CPU servers, and a rendering capability of the CPU server is relatively poor, image rendering that originally needs to be performed on the cloud phone server can be directly transferred to a computing server with a strong rendering capability, such as an existing computing server. Existing computing resources are properly used, and a hardware need for performing image rendering by the cloud phone is effectively reduced, so that implementation costs of the cloud phone are reduced, and large-scale deployment and application of the cloud phone are facilitated.

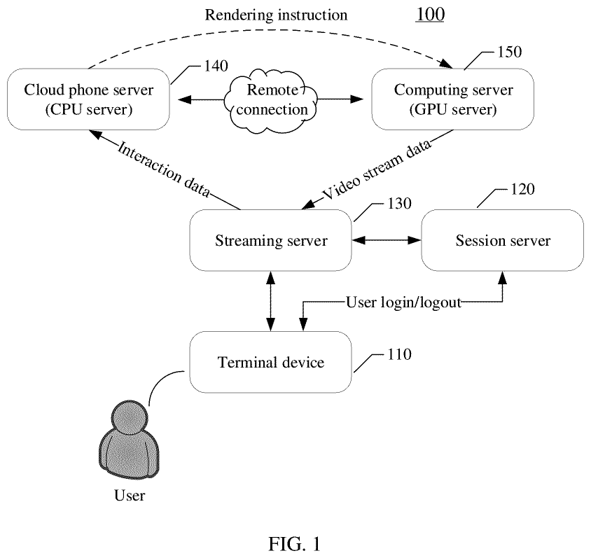

FIG. 1 is a schematic diagram illustrating a cloud rendering system 100, according to some example embodiments. As shown in FIG. 1, the system 100 can include a terminal device 110, a session server 120, a streaming server 130, a cloud phone server 140, and a computing server 150.

As shown in FIG. 1, in some implementations, the terminal device 110 is configured to run a series of applications, and output and display a corresponding application interface to a user, and the user can perform a corresponding interaction operation on the application interface. For example, the application can include an AR game or a VR game, the application interface can include a game picture, and the user can perform a corresponding interaction operation (for example, tapping or sliding) on the game picture, to control a game character to shoot, jump, etc. This is not specifically limited in the present specification.

In some implementations, the terminal device 110 can be an intelligent wearable device (for example, AR glasses or a VR helmet), a smartphone, a tablet computer, a laptop computer, a desktop computer, etc. having the above functions. This is not specifically limited in the present specification.

In some implementations, the terminal device 110 can be a terminal device based on a web, an Android operating system, an iOS operating system, etc. This is not specifically limited in the present specification.

As shown in FIG. 1, in some implementations, the cloud phone server 140 is configured to construct one or more cloud phones to provide a series of cloud computing for one or more terminal devices corresponding to the cloud phones. For example, the terminal device 110 (for example, a cloud phone client) can send a cloud phone lease request to the cloud phone server 140. Correspondingly, the cloud phone server 140 can allocate a cloud phone to the terminal device 110 to provide cloud computing for the terminal device 110. For example, the cloud phone can provide a cloud rendering service for the terminal device 110, so that a terminal device 110 with a common hardware condition can also display a smooth and clear picture based on a real-time operation.

In some implementations, the cloud phone server 140 can include a server that provides computing power based on a CPU, namely a CPU server.

In some implementations, the cloud phone server 140 can include a server based on the Android operating system, in other words, an operating system of the cloud phone server 140 can be the Android operating system, or one or more cloud phones constructed in the cloud phone server 140 have the Android operating system. In some implementations, the operating system of the cloud phone server 140 can be an operating system other than the Android operating system, for example, the iOS operating system. This is not specifically limited in the present specification.

In some implementations, the cloud phone server 140 can include a server based on an ARM architecture or any other architecture. This is not specifically limited in the present specification.

As shown in FIG. 1, in some implementations, the computing server 150 can be a third-party server connected to the cloud phone server 140, and is configured to assist the cloud phone server 140 in implementing image rendering on the cloud. In some implementations, as shown in FIG. 1, the computing server 150 can implement remote connection to the cloud phone server 140 wirelessly, for example, through a network. In some implementations, the computing server 150 can obtain a rendering instruction generated by the cloud phone server 140 based on an interaction operation performed by the user on the terminal device 110, perform corresponding image rendering based on the rendering instruction to generate a corresponding video stream, and return the video stream to the terminal device 110, so that the terminal device 110 can perform display based on the video stream. For example, in a game scenario, the terminal device 110 can receive the video stream, and display a smooth and clear game picture based on the video stream.

In some implementations, the computing server 150 can include a server that provides computing power based on a GPU, namely a GPU server. Generally, a rendering capability of the cloud phone server 140 is lower than a rendering capability of the computing server 150.

In some implementations, the computing server 150 can include a server based on the Linux operating system. In some implementations, an operating system of the computing server 150 can be an operating system other than the Linux operating system. This is not specifically limited in the present specification.

In some implementations, the computing server 150 can include a server based on an X86 architecture or any other architecture. This is not specifically limited in the present specification. As such, architectures of the cloud phone server 140 and the computing server 150 in the present specification can be different. Therefore, the cloud rendering method provided in the present specification, as described below, can be applied to heterogeneous deployment.

It is worthwhile to note that the computing server 150 shown in FIG. 1 is not merely configured to provide a rendering service for the cloud phone server. In some implementations, the computing server 150 can be further configured to perform any other calculation, for example, video encoding/decoding, deep learning training, search, and big data recommendation. This is not specifically limited in the present specification.

As shown in FIG. 1, in some implementations, the session server 120 is configured to: when the user intends to log in to the cloud phone, provide user identity authentication for the cloud phone server 140 to control user login (or access), etc. This is not specifically limited in the present specification.

As shown in FIG. 1, in some implementations, the streaming server 130 is configured to provide a data transmission channel for the terminal device 110 and the cloud phone server 140, so that the terminal device 110 can upload the interaction data of the user to the cloud phone server 140 by using the streaming server 130. In some implementations, the streaming server 130 is further configured to provide a data transmission channel for the terminal device 110 and the computing server 150, so that the computing server 150 can send the video stream obtained after image rendering to the terminal device 110 through the streaming server 130.

In the illustrated implementations, when running a corresponding application, the terminal device 110 can send interaction data of the user (including one or more interaction operations performed by the user on a corresponding application interface) to the cloud phone server 140 through the streaming server 130. Then the cloud phone server 140 generates a corresponding rendering instruction based on the received interaction data, and sends the rendering instruction to the computing server 150 connected to the cloud phone server 140. Then the computing server 150, which may be an existing computing server, parses the received rendering instruction, performs image rendering based on a parsing result to generate a corresponding video stream, and sends the video stream to the terminal device 110 (this process can also be referred to as video stream push). Finally, the terminal device 110 performs display based on the received video stream. As such, existing computing resources are properly used, GPU utilization is improved, a hardware need for performing image rendering by the cloud phone is effectively reduced, so that implementation costs of the cloud phone are reduced, and large-scale deployment and application of the cloud phone are facilitated.

In some implementations in the game scenario, image rendering is usually real-time rendering. The cloud phone server 140 may need to continuously receive a real-time interaction operation of the user uploaded by the terminal device 110, and generate a series of rendering instructions. Further, the computing server 150 continuously performs calculation based on the series of rendering instructions, and renders a game picture, so that finally, the terminal device 110 can display a correct, smooth, and clear game picture based on the real-time interaction operation of the user.

It is worthwhile to note that FIG. 1 is merely an example description. In some implementations, the system structure can alternatively include more or fewer devices, for example, can further include a database. The database can store user information such as a user account and a password. This is not specifically limited in the present specification.

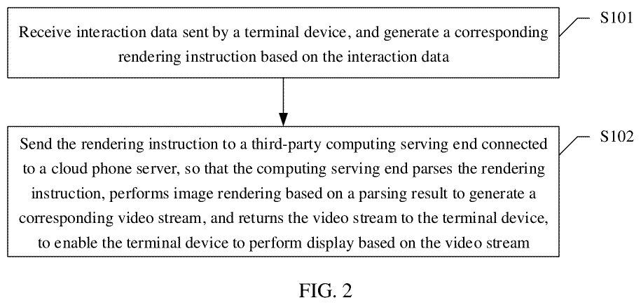

FIG. 2 is a schematic flowchart illustrating a cloud rendering method, according to some example embodiments. The method can be applied to the cloud phone server that provides computing power based on a CPU in the system 100 of FIG. 1. As shown in FIG. 2, the method can include the following step S101 and step S102.

Step S101: Receive interaction data sent by a terminal device, and generate a corresponding rendering instruction based on the interaction data.

In some implementations, the terminal device runs a corresponding application, and displays a corresponding application interface. The terminal device uploads, to a cloud phone server corresponding to the terminal device, the interaction data that is generated based on the user operation during running of the application. Correspondingly, the cloud phone server receives the interaction data uploaded by the terminal device, and generates a corresponding rendering instruction based on the interaction data.

In some implementations, the interaction data can include one or more interaction operations performed by a user on the application interface by using the terminal device. A game scenario is used as an example. For example, the interaction operation includes an interaction operation such as tapping, sliding, or dragging performed by the user on a game interface, to implement user login and control a game character to move, shoot, etc. This is not specifically limited in the present specification. Correspondingly, the rendering instruction is used to generate, through rendering, a game picture that the terminal device needs to display next based on the interaction operation of the user. The game picture can include a game background, various icons, text information, a game character, a control, etc. This is not specifically limited in the present specification.

In some implementations, the above rendering instruction generated by the cloud phone server can include a rendering instruction based on an EGL/OpenGL interface standard. In some implementations, the rendering instruction can include any other type of instruction such as a rendering instruction of an OpenGL ES interface standard. This is not specifically limited in the present specification.

In some implementations, when uploading the interaction data to the cloud phone server corresponding to the terminal device, the terminal device can upload the interaction data to the cloud phone server through a streaming server between the terminal device and the cloud phone server.

In some implementations, the terminal device can first send a connection request to the corresponding streaming server, to establish a data transmission channel between the terminal device and the streaming server.

In some implementations, the cloud phone server can also send a connection request to the streaming server, to establish a data transmission channel between the cloud phone server and the streaming server.

Then the terminal device can send the above interaction data to the streaming server based on the established data transmission channel between the terminal device and the streaming server, so that the streaming server further sends the interaction data to the cloud phone server based on the established data transmission channel between the cloud phone server and the streaming server. Correspondingly, the cloud phone server receives, based on the established data transmission channel between the cloud phone server and the streaming server, the interaction data sent by the terminal device through the streaming server.

Step S102: Send the rendering instruction to a third-party computing serving end connected to the cloud phone server, so that the computing serving end parses the rendering instruction, performs image rendering based on a parsing result to generate a corresponding video stream, and returns the video stream to the terminal device, to cause the terminal device to perform display based on the video stream.

In some implementations, after generating the corresponding rendering instruction based on the received interaction data, the cloud phone server can send the rendering instruction to the third-party computing serving end connected to the cloud phone server.

In some implementations, the third-party computing serving end can be a cloud service platform or a cloud computing service center, and can include one or more computing servers that provide computing power based on a GPU and that are shown in FIG. 1.

In some implementations, if the computing end includes a plurality of computing servers, the cloud phone server can send the rendering instruction to a target server in the plurality of computing servers included in the computing serving end, so that the target server performs image rendering based on the rendering instruction. In some implementations, the target server can be a computing server that is in the plurality of computing servers included in the computing serving end and that is connected to the cloud phone server, the target server can be a server that is in the plurality of computing servers included in the computing serving end and that has idle computing resources (in other words, has low GPU utilization), etc. This is not specifically limited in the present specification.

In some implementations, if the computing serving end includes a plurality of computing servers, the cloud phone server can send the rendering instruction to the plurality of computing servers in the computing server end that are connected to the cloud phone server, so that the plurality of computing servers jointly perform image rendering, thereby further improving image rendering efficiency, reducing a picture delay of the terminal device, etc. This is not specifically limited in the present specification.

In some implementations, after receiving the rendering instruction sent by the cloud phone server, the computing server can parse the rendering instruction to obtain the corresponding parsing result.

In some implementations, the parsing result obtained by parsing the rendering instruction by the computing server can include an instruction that is supported by the computing server and used to perform image rendering, in other words, the computing server can convert the received rendering instruction generated by the cloud phone server (CPU server) into a rendering instruction applicable to the computing server (GPU server).

Then the computing server can perform image rendering based on the parsing result to generate the corresponding video stream, and return the video stream to the terminal device, so that the terminal device performs display based on the video stream.

Specifically, in some implementations, the computing server can first perform image rendering based on the parsing result to generate a plurality of corresponding image frames. Then the computing server can perform video encoding on the plurality of image frames to obtain the corresponding video stream. Correspondingly, in some implementations, the computing server can specifically include an image renderer and a video encoder, to implement image rendering and encode a multi-frame image obtained through rendering into a video stream.

The methods for image rendering can include on-screen rendering and off-screen rendering. For the on-screen rendering, a rendering operation of a GPU is performed in a screen buffer currently used for display. For the off-screen rendering, the GPU opens a new buffer outside the current screen buffer to perform a rendering operation. For example, a method used by the computing server to perform image rendering can be off-screen rendering. For example, the off-screen rendering can be PbufferSurface-based rendering in OpenGL.

In some implementations, when returning the video stream obtained through rendering to the corresponding terminal device, the computing server can return the video stream to the corresponding terminal device through the streaming server between the terminal device and the computing server.

As described above, the terminal device can first send the connection request to the corresponding streaming server, to establish the data transmission channel between the terminal device and the streaming server.

In some implementations, the computing server can also send the connection request to the streaming server, to establish the data transmission channel between the computing server and the streaming server.

Then the computing server can send the above video stream to the streaming server based on the established data transmission channel between the computing server and the streaming server, so that the streaming server further sends the video stream to the terminal device based on the established data transmission channel between the terminal device and the streaming server. Correspondingly, the terminal device receives, based on the established data transmission channel between the terminal device and the streaming server, the video stream sent by the computing server through the streaming server.

As such, a rendering service is provided for the terminal device by using a CPU cloud phone server with the help of a GPU server in computing resources. Therefore, the computing resources are properly used, and implementation costs of the cloud phone are reduced.

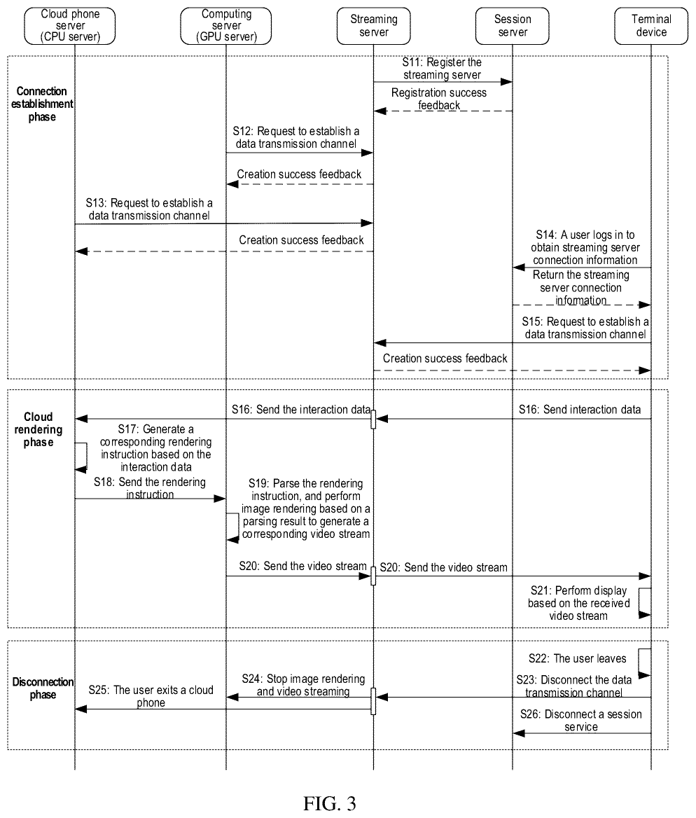

FIG. 3 is a schematic flowchart illustrating a cloud rendering method, according to some example embodiments. With reference to FIG. 3, the following describes in detail the cloud rendering method provided in the present specification from the perspective of interaction between a cloud phone server, a computing server, and a terminal device. As shown in FIG. 3, the method can include the following steps S11 to step S26.

Step S11: Register a streaming server with a session server.

As shown in FIG. 3, in some implementations, the whole process in which the cloud phone server provides a rendering service for the terminal device can include three phases: a connection establishment phase, a cloud rendering phase, and a disconnection phase. The connection establishment phase is mainly used to establish data transmission channels between the terminal device, the cloud phone server, and the computing server by using a streaming server, to support subsequent data interaction and video stream transmission.

First, as shown in FIG. 3, after self-starting, the streaming server can initiate a registration request to the session server, to register the streaming server with the session server, including registration of an address of the streaming server. Correspondingly, the session server can return a corresponding registration success feedback. In this case, the session server can store address information of the streaming server.

Step S12: The computing server requests to establish a data transmission channel between the computing server and the streaming server.

As shown in FIG. 3, after self-starting, the computing server can send a connection request to the streaming server, to establish the data transmission channel between the computing server and the streaming server. Correspondingly, the streaming server can return a corresponding creation success feedback.

In some implementations, the computing server can include an encoder, and the data transmission channel is mainly used by the encoder to push a video stream to a corresponding terminal device.

Step S13: The cloud phone server requests to establish a data transmission channel between the cloud phone server and the streaming server.

As shown in FIG. 3, after self-starting, the cloud phone server can send a connection request to the streaming server, to establish the data transmission channel between the cloud phone server and the streaming server. Correspondingly, the streaming server can return a corresponding creation success feedback.

In some implementations, the cloud phone server can include a plurality of cloud phones in a one-to-one correspondence with a plurality of terminal devices, and all of the plurality of cloud phones can send connection requests to the streaming server after self-starting, to respectively establish data transmission channels between the plurality of cloud phones and the streaming server. Subsequently, the plurality of cloud phones can respectively receive, through the data transmission channels established by the plurality of cloud phones, interaction data uploaded by the terminal devices corresponding to the plurality of cloud phones.

In some implementations, after self-starting, the cloud phone server can first load SwiftShader, to ensure smooth working of the cloud phone system.

Step S14: A user logs in to the session server by using the terminal device, to obtain streaming server connection information.

As shown in FIG. 3, the user logs in to the session server based on information such as a user account and a password by using the terminal device, to obtain the streaming server connection information returned by the session server. In some implementations, the streaming server connection information can include a streaming server address.

Step S15: The terminal device requests to establish a data transmission channel between the terminal device and the streaming server.

As shown in FIG. 3, the terminal device sends a connection request to the corresponding streaming server based on the obtained streaming server address, to establish the data transmission channel between the terminal device and the streaming server. Correspondingly, the streaming server can return a corresponding creation success feedback.

As such, the connection establishment phase before cloud rendering is officially started is completed. In embodiments of the present specification, a communication channel between the terminal device and the cloud phone is split into two channels, including a data transmission channel used to transmit interaction data to the cloud phone and a data transmission channel used to perform video stream transmission with the computing server. The two channels are jointly used by the streaming server to provide interactive access for the terminal device, so that the terminal device can normally access and use the cloud phone in any network environment, thereby improving reliability of using the cloud phone.

In some implementations, after the terminal device establishes the data transmission channel between the terminal device and the streaming server, the terminal device can notify, by using the streaming server, a corresponding cloud phone in the cloud phone server to unlock and start a cloud rendering service, and notify a renderer (for example, an off-screen renderer) in the computing server to start rendering work and the encoder to start video encoding and video streaming.

Step S16: The terminal device sends interaction data to the cloud phone server through the streaming server.

As shown in FIG. 3, the terminal device can send the above interaction data to the streaming server based on the established data transmission channel between the terminal device and the streaming server, so that the streaming server further sends the interaction data to the cloud phone server based on the established data transmission channel between the cloud phone server and the streaming server. Correspondingly, the cloud phone server receives, based on the established data transmission channel between the cloud phone server and the streaming server, the interaction data sent by the terminal device through the streaming server. In some implementations, after receiving the interaction data, the cloud phone server can return corresponding interaction feedback to the terminal device through the streaming server, etc. This is not specifically limited in the present specification.

In some implementations, data transmission can be performed between the terminal device and the streaming server by using a WebRTC real-time communications technology, and data transmission can be performed between the streaming server and the cloud phone server by using Transmission Control Protocol (TCP). In some implementations, data transmission can alternatively be performed between the streaming server and the cloud phone server by using a communication protocol other than the TCP protocol. This is not specifically limited in the present specification.

In some implementations, when the cloud phone server includes a plurality of cloud phones, the terminal device can send, through the streaming server, interaction data to a corresponding cloud phone in the plurality of cloud phones included in the cloud phone server.

Step S17: The cloud phone server generates a corresponding rendering instruction based on the interaction data.

As shown in FIG. 3, after receiving the interaction data uploaded by the terminal device, the cloud phone server can generate the corresponding rendering instruction based on the interaction data. In some implementations, the rendering instruction can be an EGL/OpenGL instruction.

In some implementations, before the terminal device sends the interaction data, the cloud phone server can first load a cloud rendering EGL dynamic library, then generate the corresponding rendering instruction based on the received interaction data and the EGL dynamic library, etc. This is not specifically limited in the present specification.

Step S18: The cloud phone server sends the rendering instruction to the computing server.

As shown in FIG. 3, after generating the rendering instruction based on the interaction data uploaded by the terminal device, the cloud phone server can send the rendering instruction to the computing server connected to the cloud phone server. Correspondingly, the computing server receives the rendering instruction sent by the cloud phone server.

In some implementations, data transmission can be performed between the cloud phone server and the computing server by using the TCP protocol. In some implementations, data transmission can alternatively be performed between the cloud phone server and the computing server by using a communication protocol other than the TCP protocol. This is not specifically limited in the present specification.

Step S19: The computing server parses the rendering instruction, and performs image rendering based on a parsing result to generate a corresponding video stream.

As shown in FIG. 3, after receiving the rendering instruction sent by the cloud phone server, the computing server can parse the rendering instruction to obtain the corresponding parsing result, and perform image rendering based on the parsing result to generate a plurality of corresponding image frames. Then the computing server can perform video encoding on the plurality of image frames to obtain the corresponding video stream.

In some implementations, the parsing result can include an instruction that is supported by the computing server and used to perform image rendering. For example, the computing server can convert a received Android image rendering instruction generated by the cloud phone server (a CPU server in an Android system) into a rendering instruction applicable to a GPU server, for example, an off-screen rendering instruction supported by the GPU server in a Linux system.

As such, CPU computing and GPU computing in an Android cloud phone can be separated (or decoupled), so that GPU computing (including image rendering) is performed by using, e.g., an existing GPU server, and an existing CPU server and GPU server in the inventory can be more properly used, thereby improving resource utilization to a certain extent, and especially, greatly improving resource utilization in the case of large-scale cloud deployment. In addition, in this application, the Android image rendering instruction can be converted into the off-screen rendering instruction in the Linux system. In addition, in a server market, a GPU driver in the Linux system is more complete than a GPU driver in the Android system. Therefore, in this application, a GPU hardware limitation is small when image rendering is implemented.

Step S20: The computing server sends the video stream to the terminal device through the streaming server.

As shown in FIG. 3, the computing server can send the above video stream to the streaming server based on the established data transmission channel between the computing server and the streaming server, so that the streaming server further sends the video stream to the terminal device based on the established data transmission channel between the terminal device and the streaming server. Correspondingly, the terminal device can receive, based on the established data transmission channel between the terminal device and the streaming server, the video stream sent by the computing server through the streaming server.

In some implementations, data transmission can be performed between the computing server and the streaming server by using the TCP protocol. In some implementations, data transmission can alternatively be performed between the computing server and the streaming server by using a communication protocol other than the TCP protocol. This is not specifically limited in the present specification.

As described above, after the computing server in this application performs rendering and encoding to obtain the video stream, the video stream can be directly pushed to the terminal device through the streaming server without passing through the cloud phone server, so that video streaming efficiency is greatly improved, a picture delay of the terminal device is reduced, and user experience is ensured.

Step S21: The terminal device performs display based on the received video stream.

As shown in FIG. 3, after receiving the video stream sent by the computing server through the streaming server, the terminal device can perform display based on the video stream. In some implementations, the terminal device can decode the video stream, and perform display based on a decoding result by using a display apparatus such as a display screen or a projector disposed on the terminal device.

As such, the cloud phone server can push, based on a real-time operation performed by the user on the terminal device, the video stream obtained through rendering to the terminal device by using, e.g., an existing GPU server, so that while being lightweight, the terminal device can display a clear and smooth picture corresponding to a real-time operation, for example, display a high-definition and smooth game picture.

In some implementations, the disconnection phase can include step S22 to step S26 shown in FIG. 3. As shown in FIG. 3, when the user leaves (Step S22), for example, the user performs an operation of quitting a game, returning to a game login interface, etc., the terminal device can disconnect, in response to the operation performed by the user, the data transmission channel established between the terminal device and the streaming server (Step S23). Further, the streaming server can notify the computing server to stop image rendering and video streaming (Step S24). Correspondingly, a user account for currently accessing the cloud phone is exited (Step S25), and the terminal device used by the user account is no longer equipped with the cloud phone to provide cloud computing (including a cloud rendering service) for the terminal device. Finally, the terminal device disconnects from the session server (Step S26). This is not specifically limited in the present specification.

In the above embodiments, the cloud phone server can receive the interaction data uploaded by the terminal device corresponding to the cloud phone server, and generate a series of rendering instructions based on the interaction data. Then the cloud phone server can forward the rendering instruction to a third-party computing serving end connected to the cloud phone server, so that the computing serving end performs image rendering based on the rendering instruction to generate a video stream to be displayed, and returns the video stream to the terminal device, to cause the terminal device to perform display based on the received video stream. As such, a CPU server with a relatively poor rendering capability can be used as a cloud phone server, and image rendering that originally needs to be performed on the cloud phone server can be directly transferred to a computing server (for example, an existing GPU server) with a strong rendering capability. Existing computing resources are properly used, GPU utilization is improved, a hardware need for performing image rendering by the cloud phone is effectively reduced, so that implementation costs of the cloud phone are reduced, and large-scale deployment and application of the cloud phone are facilitated.

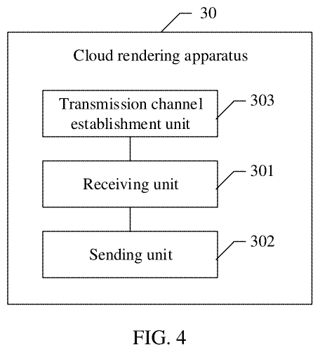

Embodiments of the present specification further provide a cloud rendering apparatus, applied to a cloud phone server corresponding to a terminal device, for example, the above cloud phone server 140 in FIG. 1 that provides computing power based on a CPU. The cloud phone server is configured to provide a rendering service for the terminal device. FIG. 4 is a schematic diagram illustrating a cloud rendering apparatus 30, according to some embodiments. As shown in FIG. 4, the apparatus 30 includes: a receiving unit 301, configured to receive interaction data sent by a terminal device, and generate a corresponding rendering instruction based on the interaction data; and a sending unit 302, configured to send the rendering instruction to a third-party computing serving end connected to a cloud phone server, so that the computing serving end parses the rendering instruction, performs image rendering based on a parsing result to generate a corresponding video stream, and returns the video stream to the terminal device, to cause the terminal device to perform display based on the video stream, where a rendering capability of the cloud phone server is lower than a rendering capability of the computing serving end.

In some implementations, the computing serving end includes at least one computing server, the cloud phone server includes a server that provides computing power based on a CPU, and the computing server includes a server that provides computing power based on a GPU.

In some implementations, the rendering instruction includes a rendering instruction based on an EGL/OpenGL interface standard.

In some implementations, the interaction data includes at least one interaction operation that is received by the terminal device and input by a user on an application interface provided by the terminal device.

In some implementations, the parsing result includes an instruction that is supported by the computing server and used to perform image rendering, and a method for performing image rendering by the computing server includes off-screen rendering.

In some implementations, the apparatus 30 further includes: a transmission channel establishment unit 303, configured to send a connection request to a corresponding streaming server, to establish a data transmission channel between the cloud phone server and the streaming server; and the receiving unit 301 is specifically configured to: receive, based on the established data transmission channel between the cloud phone server and the streaming server, the interaction data sent by the terminal device through the streaming server.

In some implementations, the cloud phone server includes a server based on an Android operating system, and the computing server includes a server based on a Linux operating system.

In some implementations, the cloud phone server includes a server based on an ARM architecture, and the computing server includes a server based on an X86 architecture.

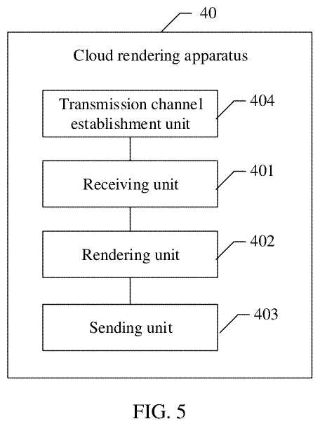

Embodiments of the present specification further provide a cloud rendering apparatus, applied to a third-party computing serving end connected to a cloud phone server, for example, including the above computing server 150 in FIG. 1 that provides computing power based on a GPU. FIG. 5 is a schematic diagram illustrating a cloud rendering apparatus 40, according to some embodiments. As shown in FIG. 5, the apparatus 40 includes: a receiving unit 401, configured to receive a rendering instruction sent by a cloud phone server, where the rendering instruction is an instruction generated by the cloud phone server based on received interaction data sent by the terminal device; a rendering unit 402, configured to parse the rendering instruction, and perform image rendering based on a parsing result to generate a corresponding video stream; and a sending unit 403, configured to send the video stream to the terminal device, so that the terminal device performs display based on the video stream, where a rendering capability of the cloud phone server is lower than a rendering capability of a computing serving end.

In some implementations, the computing serving end includes at least one computing server, the cloud phone server includes a server that provides computing power based on a CPU, and the computing server includes a server that provides computing power based on a GPU.

In some implementations, the rendering instruction includes a rendering instruction based on an EGL/OpenGL interface standard.

In some implementations, the interaction data includes at least one interaction operation that is received by the terminal device and input by a user on an application interface provided by the terminal device.

In some implementations, the rendering unit 402 is configured to: parse the rendering instruction to obtain the corresponding parsing result, where the parsing result includes an instruction that is supported by the computing server and used to perform image rendering; and perform image rendering based on the parsing result to generate a plurality of corresponding image frames, and perform video encoding on the plurality of image frames to obtain the corresponding video stream, where a method for performing image rendering by the computing server includes off-screen rendering.

In some implementations, the apparatus 40 further includes: a transmission channel establishment unit 404, configured to send a connection request to a corresponding streaming server, to establish a data transmission channel between the computing server and the streaming server; and the sending unit 403 is specifically configured to: send the video stream to the streaming server based on the established data transmission channel between the computing server and the streaming server, so that the streaming server further sends the video stream to the terminal device.

In some implementations, the cloud phone server includes a server based on an Android operating system, and the computing server includes a server based on a Linux operating system.

In some implementations, the cloud phone server includes a server based on an ARM architecture, and the computing server includes a server based on an X86 architecture.

For an implementation process of functions and roles of units in the apparatus 30 and the apparatus 40, references can be made to descriptions of the embodiments corresponding to FIG. 1 to FIG. 3. Details are omitted here for simplicity. It should be understood that each unit in the apparatus 30 and the apparatus 40 can be implemented by using software, or hardware, or a combination of software and hardware. For example, as a logical apparatus, the apparatus is formed by reading corresponding computer program instructions to a memory and running the instructions in the memory by a central processing unit (CPU) in a device where the apparatus is located. Also for example, in addition to a CPU and a memory, the device where the apparatus is located usually further includes other hardware such as a chip for sending and receiving radio signals, and/or other hardware such as a card for implementing a network communication function.

The above apparatus implementation is merely an example. The units described as separate parts may or may not be physically separate, and parts displayed as units may or may not be physical modules, may be located in one position, or may be distributed on a plurality of network modules. Some or all of the units can be selected depending on an actual need to achieve the objectives of the solutions of the present specification.

In some implementations, the units described in the above embodiments can be implemented by a computer chip or an entity, or can be implemented by a product with a certain function. A typical implementation device is a computer, and the computer can be specifically a personal computer, a laptop computer, a cellular phone, a camera phone, a smartphone, a personal digital assistant, a media player, a navigation device, an email receiving and sending device, a game console, a tablet computer, a wearable device, or any combination of these devices.

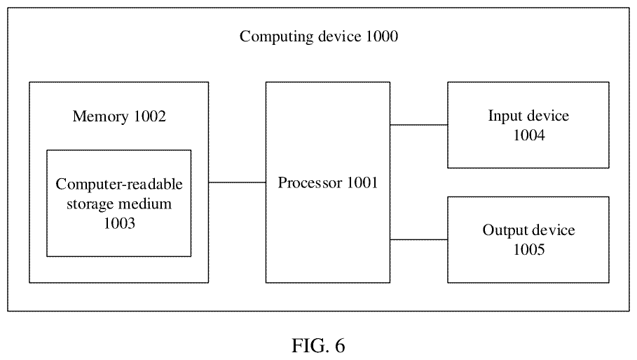

Embodiments of the present specification further provide a computing device. FIG. 6 is a schematic diagram illustrating a computing device 1000, according to some embodiments. The computing device 1000 can be the above cloud phone server or the above computing server. As shown in FIG. 6, the computing device 1000 includes a processor 1001 and a memory 1002, and can further include an input device 1004 (such as a keyboard) and an output device 1005 (such as a display). The processor 1001, the memory 1002, the input device 1004, and the output device 1005 can be connected through a bus or in another way. As shown in FIG. 6, the memory 1002 includes a computer-readable storage medium 1003, and the computer-readable storage medium 1003 stores a computer program that can be run by the processor 1001. The processor 1001 can be a general-purpose central processing unit, a microprocessor, or an integrated circuit configured to control execution of the above method embodiments. When running the stored computer program, the processor 1001 can perform the cloud rendering method described above, including: receiving interaction data sent by a terminal device, and generating a corresponding rendering instruction based on the interaction data; and sending the rendering instruction to a third-party computing serving end connected to a cloud phone server, so that the computing serving end parses the rendering instruction, performs image rendering based on a parsing result to generate a corresponding video stream, and returns the video stream to the terminal device, to cause the terminal device to perform display based on the video stream, where a rendering capability of the cloud phone server is lower than a rendering capability of the computing serving end. For detailed descriptions of the steps of the above cloud rendering method, references can be made to the above content.

Embodiments of the present specification further provide a non-transitory computer-readable storage medium. The storage medium stores a computer program. When the computer program is executed by a processor, the cloud rendering method described above is performed. For details, references can be made to the above descriptions of the embodiments corresponding to FIG. 1 to FIG. 3.

Embodiments of the present specification further provide a terminal device that includes one or more central processing units (CPUs), input/output interfaces, network interfaces, and memories.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data.

Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. In the present specification, the computer-readable medium does not include a transitory computer-readable medium, for example, a modulated data signal and carrier.

It is worthwhile to further note that the terms “include”, “contain”, or their any other variants are intended to cover a non-exclusive inclusion, so a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that embodiments of the present specification can be provided as a method, a system, or a computer program product. Therefore, the embodiments of the present specification can be implemented using hardware, or software, a combination of software and hardware. Moreover, embodiments of the present specification can be implemented using a computer program product that is implemented on one or more computer-usable storage media (including but not limited to a disk memory, a CD-ROM, an optical memory, etc.) that include computer-usable program code.

The above descriptions are merely example embodiments of the present specification, but are not intended to limit the present specification. Any modification, equivalent replacement, or improvement made without departing from the spirit and principle of the present specification shall fall within the protection scope of the present specification.

What is claimed is:

1. A cloud rendering method, applied to a cloud phone server corresponding to a terminal device, wherein the cloud phone server is configured to provide a rendering service for the terminal device, and the method comprises:
receiving interaction data sent by the terminal device, and generating a rendering instruction based on the interaction data; and
sending the rendering instruction to a computing serving end connected to the cloud phone server, so that the computing serving end parses the rendering instruction, performs image rendering based on a parsing result to generate a video stream, and returns the video stream to the terminal device, to cause the terminal device to perform display based on the video stream,
wherein a rendering capability of the cloud phone server is lower than a rendering capability of the computing serving end.

2. The method according to claim 1, wherein the computing serving end comprises at least one computing server, the cloud phone server comprises a server that provides computing power based on a CPU, and the computing server comprises a server that provides computing power based on a GPU.

3. The method according to claim 2, wherein the rendering instruction comprises a rendering instruction based on an EGL/OpenGL interface standard.

4. The method according to claim 2, wherein the interaction data comprises at least one interaction operation that is received by the terminal device and input by a user on an application interface provided by the terminal device.

5. The method according to claim 2, wherein the parsing result comprises an instruction that is supported by the computing server to perform image rendering, and performing image rendering by the computing server comprises off-screen rendering.

6. The method according to claim 2, further comprising:
sending a connection request to a streaming server, to establish a data transmission channel between the cloud phone server and the streaming server; and
receiving the interaction data sent by the terminal device comprises:
receiving, based on the established data transmission channel between the cloud phone server and the streaming server, the interaction data sent by the terminal device through the streaming server.

7. The method according to claim 2, wherein the cloud phone server comprises a server based on an Android operating system, and the computing server comprises a server based on a Linux operating system.

8. The method according to claim 2, wherein the cloud phone server comprises a server based on an ARM architecture, and the computing server comprises a server based on an X86 architecture.

9. A cloud rendering method, applied to a computing serving end connected to a cloud phone server, wherein the cloud phone server is configured to provide a rendering service for a terminal device, and the method comprises:
receiving a rendering instruction sent by the cloud phone server, wherein the rendering instruction is generated by the cloud phone server based on received interaction data sent by the terminal device;
parsing the rendering instruction, and performing image rendering based on a parsing result to generate a video stream; and
sending the video stream to the terminal device, so that the terminal device performs display based on the video stream, wherein a rendering capability of the cloud phone server is lower than a rendering capability of the computing serving end.

10. The method according to claim 9, wherein the computing serving end comprises at least one computing server, the cloud phone server comprises a server that provides computing power based on a CPU, and the computing server comprises a server that provides computing power based on a GPU.

11. The method according to claim 10, wherein the rendering instruction comprises a rendering instruction based on an EGL/OpenGL interface standard.

12. The method according to claim 10, wherein the interaction data comprises at least one interaction operation that is received by the terminal device and input by a user on an application interface provided by the terminal device.

13. The method according to claim 10, wherein parsing the rendering instruction, and performing image rendering based on the parsing result to generate the video stream comprises:
parsing the rendering instruction to obtain the parsing result, wherein the parsing result comprises an instruction that is supported by the computing server to perform image rendering; and
performing image rendering based on the parsing result to generate a plurality of image frames, and performing video encoding on the plurality of image frames to obtain the video stream, wherein performing image rendering by the computing server comprises off-screen rendering.

14. The method according to claim 10, further comprising:
sending a connection request to a streaming server, to establish a data transmission channel between the computing server and the streaming server; and
sending the video stream to the terminal device comprises:
sending the video stream to the streaming server based on the established data transmission channel between the computing server and the streaming server, so that the streaming server further sends the video stream to the terminal device.

15. The method according to claim 10, wherein the cloud phone server comprises a server based on an Android operating system, and the computing server comprises a server based on a Linux operating system.

16. The method according to claim 10, wherein the cloud phone server comprises a server based on an ARM architecture, and the computing server comprises a server based on an X86 architecture.

17. A cloud phone server, wherein the cloud phone server corresponds to a terminal device and is configured to provide a rendering service for the terminal device, the cloud phone server comprising:
a processor; and
a memory storing instructions executable by the processor,
wherein the processor is configured to:
receive interaction data sent by the terminal device, and generate a rendering instruction based on the interaction data; and
send the rendering instruction to a computing serving end connected to the cloud phone server, so that the computing serving end parses the rendering instruction, performs image rendering based on a parsing result to generate a video stream, and returns the video stream to the terminal device, to cause the terminal device to perform display based on the video stream,
wherein a rendering capability of the cloud phone server is lower than a rendering capability of the computing serving end.

18. A computing serving end connected to a cloud phone server, wherein the cloud phone server is configured to provide a rendering service for a corresponding terminal device, the computing serving end comprising:
a processor; and
a memory storing instructions executable by the processor,
wherein the processor is configured to perform the method according to claim 9.

19. A non-transitory computer-readable storage medium having stored thereon a computer program that, when executed by a processor, causes the processor to perform the method according to claim 1.

20. A non-transitory computer-readable storage medium having stored thereon a computer program that, when executed by a processor, causes the processor to perform the method according to claim 9.
